(19) United States
(12) Patent Application Publication
(10) Pub. No.: US 2016/0334813 A1
(43) Pub. Date: Nov. 17, 2016

(54) CUSTOMIZED INSOLE TEMPERATURE CONTROLLER

(71) Applicant: WOOIN CO., LTD, Busan (KR)

(72) Inventors: Geun-chul PARK, Yangsan-si (KR); Jong-seok SONG, Busan (KR); Seung-hee LEE, Busan (KR)

(73) Assignee: WOOIN CO., LTD, Busan (KR)

(21) Appl. No.: 15/112,150

(22) PCT Filed: Jan. 13, 2015
(86) PCT No.: PCT/KR2015/000338

§ 371 Date: Jul. 15, 2016

(30) Foreign Application Priority Data
Jan. 16, 2014 (KR) 10-2014-0005461

(51) Int. Cl. G05D 23/19; H05B 1/02

(52) U.S. Cl. CPC G05D 23/1927; H05B 1/0252

(57) ABSTRACT

The present invention relates to a customized insole temperature controller, and the purpose of the present invention is to provide a customized insole temperature controller for controlling power supply and temperature solely by a wire leading out of a heating sheet, without adding a separate sensor to the insole, thereby preventing any fire or damage to the human body resulting from overheating, and thereby heating a thermoplastic resin to the target softening temperature and maintaining the same. To this end, the present invention provides a temperature controller for supplying a customized insole with power, comprising: a heating sheet comprising a heating unit having a resistor and an electrode printed on an insulation sheet; and a thermoplastic resin sheet provided beneath the heating sheet and deformed according to the temperature of the heating unit, and, as the technical gist of the present invention, the temperature controller comprises: a switching unit connected in series to an end of the electrode of the heating sheet to connect/disconnect a power supply; a current detection unit connected in series between a source of the switching unit and an end of the power supply; a voltage detection unit for detecting a power voltage using partial voltage resistance; a DC power unit for dropping AC power, rectifying the same, and supplying DC power; a temperature detection unit for detecting ambient temperature; a manipulation/display unit having buttons for function manipulation and a display for operation state display formed thereon; and a control unit electrically connected with elements ranging from the switching unit to the manipulation/display unit to transmit/receive a power voltage supply or control signal and control the temperature of the heating sheet according to a preset algorithm.

### TECHNICAL FIELD

The present invention relates to a customized insole temperature controller, and in particular to a customized insole temperature controller which allows to manufacture an insole fitting well into an orderer's foot shape in such a way to mold in a flexible state without damaging a thermoplastic resin by electrically heating a heating sheet inside of an insole.

### BACKGROUND ART

The technology related with the present invention is disclosed in the Korean patent registration No. 10-1258581 the title of which is “a customized insole and customized sandals”.

FIG. 1 is a cross sectional view illustrating a conventional customized insole, and FIG. 2 is an example view illustrating a heating sheet for a customized insole wherein a heating part and an electrode are printed.

The disclosed conventional technology is directed to manufacturing an insole or sandals which can be fitted into an orderer's foot shape, thus maximizing a wearing feeling and minimizing any fatigability. Referring to FIGS. 1 and 2, an outer layer 1 and an inner layer 2 are laminated from top to bottom. An electric power supply terminal 5 is connected to a heating member 4 on which a thermoplastic resin sheet 3 laminated underneath the inner layer 2 is printed, thus supplying an electric power to the heating part 4. When the thermoplastic resin sheet 3 is smoothened by the heat generating by the heating part 4, the electric power is turned off, and an orderer inputs a smoothened insole 7 into a shoe and steps in the shoe, by which the thermoplastic resin sheet 3 can be deformed matching with the oderer's foot shape. The thusly deformed insole is cooled and hardened at a room temperature, thus manufacturing a customized insole which can be fitted well into an orderer's foot shape.

The conventional technology is able to greatly reduce a customizing work process since a heat generating device, which could be alternatively substituted with an electric oven or the like, is not used. A customized molding is available wherever an electric power can be supplied, thus effectively increasing a work accessibility.

In the conventional technology, a heating resistor of a heating sheet of a heating member disposed at an insole can be made using various materials. A resistance value appropriate to the heating of a thermoplastic resin can be obtained by adjusting the mixing ratio of a conductive paint formed of carbon and silver powder and the thickness or width of a coated film.

The aforementioned conventional technology does not specifically disclose a means for appropriately heating the insole with respect to any changing factors in terms of temperature due to various causes, for example, a surrounding temperature at the time of heating, a change in an electric power voltage, a resistance distribution of a heating element, etc.

More specifically, in a conventional customized insole and sandals, when heating a heating sheet in FIG. 2, it needs to control temperatures while avoiding any fire due to an overheating and without injuring a human body. In order to satisfy the aforementioned condition, if a temperature sensor is attached to an insole, the temperature might be substantially controlled by a conventionally known technology, but if the sensor is installed in the insole, the user may feel the presence of a foreign substance when wearing, and it is not easy to attach the sensor due to the configuration of the insole of a sheet shape, and in particular a wiring work is not easy, for which a manufacturing cost may increase.

### DISCLOSURE OF INVENTION

Accordingly, the present invention is made in an effort to resolve the aforementioned problems. It is a first object of the present invention to provide a customized insole temperature controller wherein it is possible to heat up to a targeted temperature which is high enough to smoothen a thermoplastic resin and maintain the heated temperature, while preventing any fire due to an overheating or any damage to a human body, in such a way to control the supply of an electric power and temperatures using only an electric cable which extends from a heating sheet, without adding a sensor to the insole.

To achieve the above objects, there is provided a temperature controller for supplying a customized insole with power, which is formed of a heating sheet comprising a heating unit having a resistor and an electrode printed on an insulation sheet; and a thermoplastic resin sheet provided beneath the heating sheet and deformed according to the temperature of the heating unit, which may include, but is not limited to, a switching unit connected in series to an end of the electrode of the heating sheet to connect/disconnect a power supply; a current detection unit connected in series between a source of the switching unit and an end of the power supply; a voltage detection unit for detecting a power voltage using partial voltage resistance; a DC power unit for dropping AC power, rectifying the same, and supplying DC power; a temperature detection unit for detecting ambient temperature; a manipulation/display unit having buttons for function manipulation and a display for operation state display formed thereon; and a control unit electrically connected with elements ranging from the switching unit to the manipulation/display unit to transmit/receive a power voltage supply or control signal and control the temperature of the heating sheet according to a preset algorithm.

Here, the switching unit is formed of a triac or thyristor (SCR).

### ADVANTAGEOUS EFFECTS OF THE INVENTION

According to the embodiments of the present invention, it is possible to heat up to a targeted temperature which is high enough to smoothen a thermoplastic resin sheet and maintain the heated temperature, while preventing any fire due to an overheating or any damage to a human body, in such a way to control the supply of an electric power and temperatures using only an electric cable which extends from a heating sheet, without adding a sensor to the insole.

### BRIEF DESCRIPTION OF DRAWINGS

FIG. 1 is a cross sectional view illustrating a conventional customized insole.

FIG. 2 is a view illustrating an example of a heating sheet for a customized insole on which a heating part and an electrode in FIG. 1 are printed.

FIG. 3 is a concept view illustrating a heating sheet which has been used for a temperature characteristic experiment of a customized insole temperature controller according to an embodiment of the present invention.

FIG. 4 is a block diagram illustrating a customized insole temperature controller according to an embodiment of the present invention.

FIG. 5 is a graph showing the temperatures inside of an insole which is measured using a customized insole temperature controller according to an embodiment of the present invention.

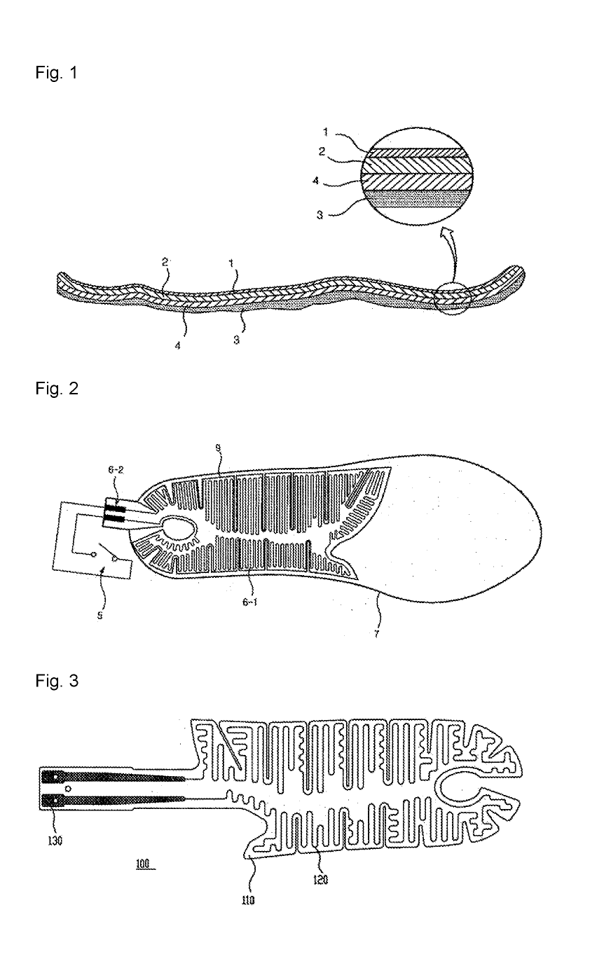

### BEST MODES FOR CARRYING OUT THE INVENTION

The preferred embodiments of the present invention will be described in details with reference to the accompanying drawings. The illustrations and detailed descriptions on the configuration that a person having ordinary skill in the art can easily know and the operations and effects thereof will be simplified or omitted, and the present invention will be described with the portions related with the present invention.

Referring to FIG. 3, the customized insole temperature controller 200 according to an embodiment of the present invention is intended to be applied and used for a customized insole which may include a heating sheet 100 formed of a heating unit wherein a resistor (a heating cable 120) and an electrode 130 are printed on an insulation sheet 110, and a thermoplastic resin sheet (not illustrated) which is disposed underneath the heating sheet 100 and deforms based on the temperature of the heating sheet 100.

The heating resistor 120 printed on the heating sheet 100 may be made of various materials, and a predetermined resistance value appropriate to a thermoplastic resin can be obtained in such a way to adjust a mixing ratio of a conductive paint formed of carbons and silver powders and the thickness and width of a coated film. The temperature coefficient of a carbon and silver-mixed resistor which corresponds to a conductive paint printed in a line shape, may be about 0.26[%/° C.] which might be obtained from an actual measurement.

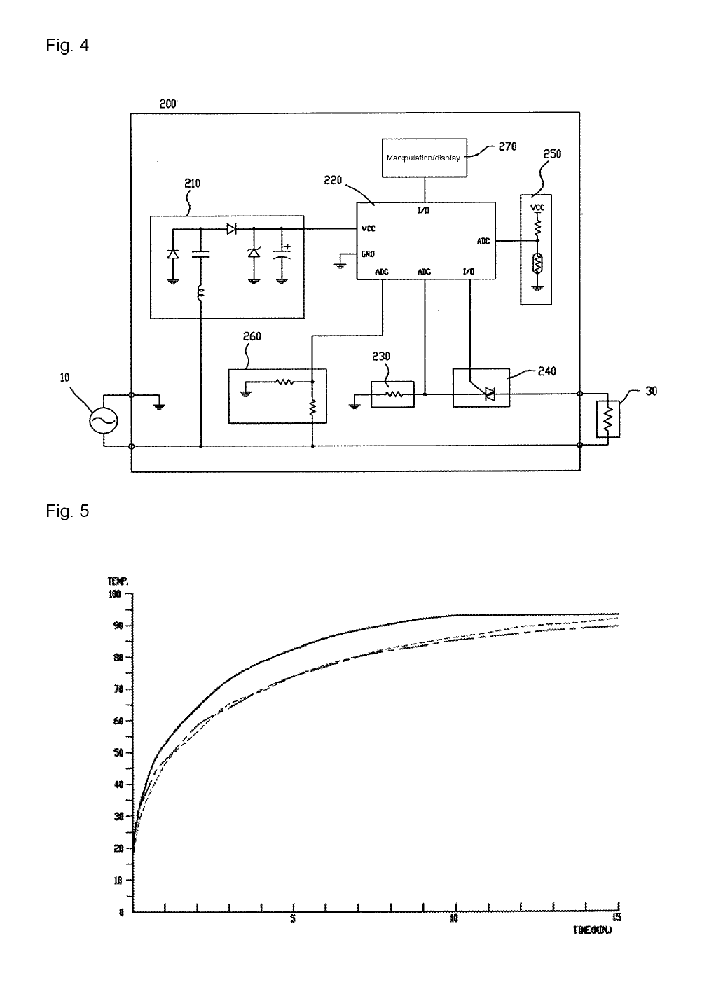

As illustrated in FIG. 4, the present invention may include, but is not limited to, a switching unit 240, a current detection unit 230, a voltage detection unit 260, a DC power unit 210, a temperature detection unit 250, a manipulation display unit 270, and a control unit 220. An end of the electric power 10 may be a common ground of a circuit and may be a reference point of an ADC value which allows to recognize the value of the current detection unit 230 that the control unit (a microprocessor 220) detects the current using a shunt resistance.

The switching unit 240 may be formed of a triac or thyristor (SCR) and may be connected in series to an end of the electrode 130 of the heating sheet 100, thus intermitting the electric power.

The current detection unit 230 may be formed of a resistor and may be connected in series between the source of the switching unit 240 and an end of the electric power, thus detecting current.

The voltage detection unit 260 may be formed of a divide voltage, thus detecting an electric power voltage.

When the current is limited by the impedance values of an inductor and a condenser, the DC power unit 210 will rectify it with a diode, so the voltage can be limited by a constant voltage diode and can be smoothened by an electrolytic condenser, whereby the power can be used for a DC power for controls.

The temperature detection unit 250 is employed to detect a surrounding temperature and is preferably installed where it can be directly exposed to an external air at a distance as long as possible from elements which can be easily heated in the circuit. The temperature detection unit 250 may detect a surrounding temperature and transmit to a control unit. The temperature detection unit 250 may be formed of a NTC (Negative Temperature Coefficient) thermistor, which is a thermistor wherein an electric resistance can continuously change with a negative temperature coefficient. It is mainly produced by a metallic oxide semiconductor. There may be an organic material, a Si-single crystal material, a SiC material, etc. which can be used as a temperature sensor of the temperature detection unit according to the present invention.

The manipulation display unit 270 is configured in a structure which is disposed exposed to the outside. At one side of the manipulation display unit 270, there may be a button to manipulate the functions, and at the other side thereof, there may be display to display the operation states based on the function manipulations.

The control unit 220 is electrically connected to all the aforementioned components, by which an electric power voltage can be supplied to each component or a control signal can be transmitted or received. The control unit may be formed of a typical microprocessor. A program including an algorithm for the sake of a temperature control of a heating sheet in the inside of the insole will be embedded therein.

The control unit 220 is able to control the temperatures of the heating sheet based on an algorithm of the embedded program, the detailed method of which is as follows.

First, the temperature of the insole means the temperature of the heating sheet 100 and corresponds to a value which may be calculated with the surrounding temperature, a change amount of the current at the resistor 120 (hereinafter referred to a heating wire), and the temperature coefficient of the heating wire. This may be calculated by the following formula 1.

Temperature of heating wire=surrounding temperature+((initial current/heating wire current)−1)/temperature efficient of heating wire Formula 1

Here, the surrounding temperature means the temperature of air detected by the temperature detection unit 250 at the time where the temperature control starts, and the temperature coefficient of the heating wire 120 means a ratio of the change in the resistance value of the heating wire 120 based on the change in temperatures.

If the temperature control starts based on the formula 1, the surrounding temperature and the current at the load (the heating sheet of the insole) are detected. In case of the initial temperature where the control starts, the surrounding temperature first measured based on the formula 1 may become the temperature of the inside of the insole.

If the supply of the electric power starts, the temperature of the insole increases, and at the same time, the resistance value of the heating wire 120 increases in proportion thereto, so the current decreases, and a continuous temperature change can be detected.

If the temperature increase exceeds a targeted value, the electric power is blocked, and the electric power is supplied for a second after a predetermined time has passed, and then the current is measured, and if the temperature is lower than the target value, the temperature is increased by continuously supplying the electric power. The heating is carried out for a predetermined time period so as to obtain a targeted temperature target, and if the temperature reaches the finally targeted temperature after the whole insole portions have been heated enough, it will be displayed on the screen so that the user can recognize that the heating has been completed.

As a result of the control of the temperature of the insole according to the present invention based on the aforementioned configuration and algorithm, the control in FIG. 5 can be obtained. The solid line in the graph in FIG. 5 shows a temperature characteristic profile of an ideal insole, namely, a temperature characteristic programmed in the temperature controller, and the dotted line and the alternate long and short dash line represents an actual temperature change inside of the insole, from which it is known that the ideal temperature can be converged and obtained near when about 15 minutes have passed.

According to the present invention described so far, the supply of the electric power and the temperature can be controlled only with an electric cable which extends from the heating sheet without adding a sensor to the insole, so it can be heated up to the target temperature at which the thermoplastic resin sheet can be smoothened, while preventing any fire due to an overheating and any damage to a human body, and can be maintained, by means of which a customized insole temperature controller according to the present invention can be provided.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The present invention relates to a customized insole temperature controller, and in particular it can be applicable to a customized insole temperature controller which allows to manufacture an insole fitting well into an orderer's foot shape in such a way to mold in a flexible state without damaging a thermoplastic resin by electrically heating a heating sheet inside of an insole.

1. A temperature controller for supplying a customized insole with power, which is formed of a heating sheet comprising a heating unit having a resistor and an electrode printed on an insulation sheet; and a thermoplastic resin sheet provided beneath the heating sheet and deformed according to the temperature of the heating unit, comprising:
a switching unit connected in series to an end of the electrode of the heating sheet to connect/disconnect a power supply;
a current detection unit connected in series between a source of the switching unit and an end of the power supply;
a voltage detection unit for detecting a power voltage using partial voltage resistance; a DC power unit for dropping AC power, rectifying the same, and supplying DC power;
a temperature detection unit for detecting ambient temperature; a manipulation/display unit having buttons for function manipulation and a display for operation state display formed thereon; and
a control unit electrically connected with elements ranging from the switching unit to the manipulation/display unit to transmit/receive a power voltage supply or control signal and control the temperature of the heating sheet according to a preset algorithm.

2. The controller of claim 1, wherein the switching unit is formed of a triac or thyristor (SCR).
